(19) United States
(12) Patent Application Publication
(10) Pub. No.: US 2026/0241693 A1
(43) Pub. Date: Aug. 20, 2026

(54) PRINTING APPARATUS

(71) Applicant: MIMAKI ENGINEERING CO., LTD., Nagano (JP)

(72) Inventors: Katsutoshi Yamabe, Nagano (JP); Hiroyoshi Takano, Nagano (JP)

(73) Assignee: MIMAKI ENGINEERING CO., LTD., Nagano (JP)

(21) Appl. No.: 19/161,269

(22) PCT Filed: Mar. 14, 2024
(86) PCT No.: PCT/JP2024/009914

§ 371 Date: Aug. 31, 2025

(30) Foreign Application Priority Data
Mar. 15, 2023 (JP) 2023-041359

(51) Int. Cl. B41J 2/165; B41J 25/00

(52) U.S. Cl. CPC B41J 2/16538; B41J 2/16544; B41J 25/005; B41P 2235/20

(57) ABSTRACT

Ink on a nozzle surface is appropriately wiped out. A wiper unit includes a wiping portion that wipes a nozzle surface of an ejecting head having a nozzle surface on which a nozzle for ejecting ink is formed, and a driving unit that moves the wiping portion in a wiping direction along the nozzle surface. The wiping portion includes two wiping members arranged side by side in the wiping direction and having different hardnesses, and a holding portion that integrally holds the two wiping members.

### TECHNICAL FIELD

The present invention relates to a printing apparatus.

### BACKGROUND ART

In a printing apparatus having an ejecting head that ejects ink from a nozzle formed on a nozzle surface, a wiper unit that wipes off the ink adhered to the nozzle surface of the ejecting head is provided (see, for example, Patent Literature 1).

### CITATION LIST

### Patent Literature

Patent Literature 1: Japanese Patent No. 5740431

### SUMMARY OF INVENTION

### Technical Problems

In the wiper unit as described above, when the nozzle surface is wiped using an elastically deformable wiping member such as a rubber material, there is a possibility that the dried or solidified ink cannot be sufficiently removed. On the other hand, when wiping the nozzle surface using a wiping member having high hardness to remove the dried or solidified ink, the ink can be removed, but there is a possibility that the mist or droplet of the ink that is not dried or solidified cannot be sufficiently removed.

The present invention has been made in view of the above, and an object thereof is to provide a printing apparatus capable of appropriately removing ink on a nozzle surface.

### Solutions to Problems

A printing apparatus according to the present disclosure includes an ejecting head having a nozzle surface in which a plurality of nozzles for ejecting ink are formed in a row at predetermined intervals; a wiping portion that wipes the nozzle surface; and a driving unit that relatively moves the nozzle surface and the wiping portion, in which the ejecting head ejects the ink to a printing target mounted in a printing area while moving in a main scanning direction set in advance, and the wiping portion includes two wiping members having different hardnesses arranged side by side in a direction in which the nozzle surface and the wiping portion relatively move at the time of wiping the nozzle surface, and a holding portion that integrally holds the two wiping members.

### Effect of the Invention

According to the present invention, the ink on the nozzle surface can be appropriately wiped off.

### BRIEF DESCRIPTION OF THE DRAWINGS

FIG. 1 is a perspective view schematically illustrating an example of a printing apparatus according to the present embodiment.

FIG. 2 is a view illustrating an example of a wiping portion of a wiper unit.

FIG. 3 is a view illustrating an example of a wiping portion of a wiper unit.

FIG. 4 is a view illustrating an example of a wiping operation by a wiper unit.

FIG. 5 is a view illustrating an example of a wiping operation by a wiper unit.

FIG. 6 is a view illustrating an example of a wiping operation by a wiper unit.

FIG. 7 is a view illustrating an example of a wiping operation by a wiper unit.

FIG. 8 is a view illustrating an example of a wiping operation by a wiper unit.

FIG. 9 is a view illustrating an example of a wiping operation by a wiper unit.

FIG. 10 is a view illustrating an example of a wiping operation by a wiper unit.

FIG. 11 is a view illustrating an example of a wiping operation by a wiper unit.

FIG. 12 is a view illustrating an example of a wiping operation by a wiper unit.

FIG. 13 is a view illustrating another example of an ejecting head.

FIG. 14 is a view illustrating an example of a case where wiping is performed by the wiper unit on the ejecting head illustrated in FIG. 13.

FIG. 15 is a view illustrating an example of a case where wiping is performed by the wiper unit on the ejecting head illustrated in FIG. 13.

FIG. 16 is a view illustrating an example of a case where wiping is performed by the wiper unit on the ejecting head illustrated in FIG. 13.

FIG. 17 is a view illustrating an example of a case where wiping is performed on the ejecting head illustrated in FIG. 13 by a wiper unit according to another configuration.

FIG. 18 is a view illustrating an example of a case where wiping is performed on the ejecting head illustrated in FIG. 13 by a wiper unit according to another configuration.

FIG. 19 is a view illustrating an example of a case where wiping is performed on the ejecting head illustrated in FIG. 13 by a wiper unit according to another configuration.

FIG. 20 is a view illustrating an example of a case where wiping is performed on the ejecting head illustrated in FIG. 13 by a wiper unit according to another configuration.

FIG. 21 is a view illustrating an example of a case where wiping is performed on the ejecting head illustrated in FIG. 13 by a wiper unit according to another configuration.

FIG. 22 is a view illustrating an example of a printing apparatus according to another configuration.

### DESCRIPTION OF EMBODIMENTS

Hereinafter, an embodiment of a printing apparatus according to the present invention will be described with reference to the drawings. Note that the present invention is not limited by the embodiment. In addition, constituent elements in the following embodiments include those that can be easily replaced by those skilled in the art or those that are substantially the same.

In the present embodiment, directions in the drawing will be described using an XYZ coordinate system. In the XYZ coordinate system, a plane parallel to a floor surface on which the inkjet printer is placed is an XY plane. In the XY plane, a conveyance direction of a recording medium to be described later is referred to as an X direction, and a direction orthogonal to the X direction on the XY plane is referred to as a Y direction. A direction perpendicular to the XY plane is referred to as a Z direction. In each of the X direction, the Y direction, and the Z direction, it is assumed that a direction of an arrow in the drawing is a + direction, and a direction opposite to the direction of the arrow is a − direction. In the present embodiment, the +Z direction may be referred to as upward.

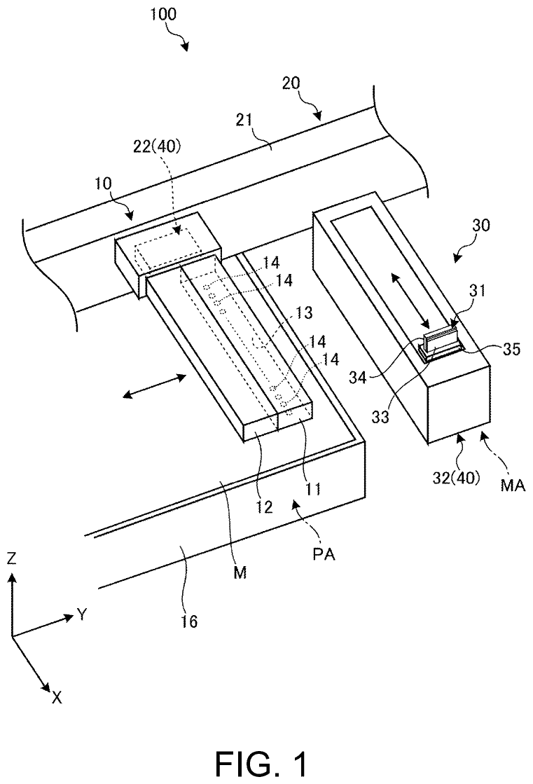

FIG. 1 is a perspective view schematically illustrating an example of the printing apparatus according to the present embodiment. A printing apparatus 100 illustrated in FIG. 1 is an ink jet printer that performs printing on a medium M by an ink jet method. The printing apparatus 100 includes a carriage 10, a guide mechanism 20, and a wiper unit 30.

The carriage 10 is guided by the guide mechanism 20 and can reciprocate in the Y direction (main scanning direction). The carriage 10 is provided with an ejecting head 11 and a light irradiation device 12.

The ejecting head 11 ejects ink toward the medium M in a printing area PA. The medium M is arranged on a platen 16 in the printing area PA. The ejecting head 11 has a nozzle surface (nozzle-formed surface) 13. The nozzle surface 13 has, for example, a planar shape, and nozzles 14 for ejecting ink are formed. The nozzle surface 13 is subjected to a water-repellent treatment in order to maintain a consistent meniscus of ink in the nozzle 14. For example, a plurality of nozzles 14 are arranged in a predetermined direction. Examples of the ink include ultraviolet-curable inks. As the type of the ultraviolet-curable ink, for example, coloring inks such as white ink, cyan (C), magenta (M), yellow (Y), and black (K), transparent ink, and the like can be appropriately used according to the hue of the image to be formed on the medium M, and the like. Even in the case of ink other than the ultraviolet-curable ink, ink in which a solid material easily adheres to the nozzle surface by drying and curing of the ink, such as a latex ink, can be appropriately used. For example, assuming that the longest time required for the ejecting head 11 to reach a position facing the wiping portion 31 after ejecting the ink for the last time in the main scanning direction (Y direction) is the longest non-ejection time, for example, ink in which the droplets of the ink adhered to the nozzle surface 13 solidify at least during the longest non-ejection time can be used as the ink.

The light irradiation device 12 irradiates the ultraviolet-curable ink ejected onto the medium M with ultraviolet radiation. The light irradiation device 12 includes, for example, an LED module or the like capable of emitting ultraviolet rays. The light irradiation device 12 reciprocates in the main scanning direction integrally with the ejecting head 11 by the movement of the carriage 10.

The guide mechanism 20 guides the carriage 10 in the Y direction. The guide mechanism 20 includes a guide rail 21. The guide rail 21 extends along the Y direction. The guide mechanism 20 includes a first drive mechanism 22 that moves the carriage 10 in the Y direction. The first drive mechanism 22 includes, for example, a drive source such as a motor and a transmission mechanism. The carriage 10 moves in the Y direction along the guide rail 21 by the driving force generated by the driving source of the first drive mechanism 22. The first drive mechanism 22 constitutes a driving unit 40 together with a second drive mechanism 32 described later. The driving unit 40 relatively moves the nozzle surface 13 and the wiping portion 31.

The wiper unit 30 is provided in a maintenance area MA of the printing apparatus 100. The maintenance area MA is disposed outside the printing area PA in the Y direction. The wiper unit 30 wipes the nozzle surface 13 of the ejecting head 11. The wiper unit 30 includes a wiping portion 31 and the second drive mechanism 32. The wiping portion 31 is disposed at at least at one position on a line extending in the Y direction, which is the main scanning direction, and in the present embodiment, at a predetermined position on the +Y side of the platen 16, to face the nozzle surface 13 of the ejecting head 11.

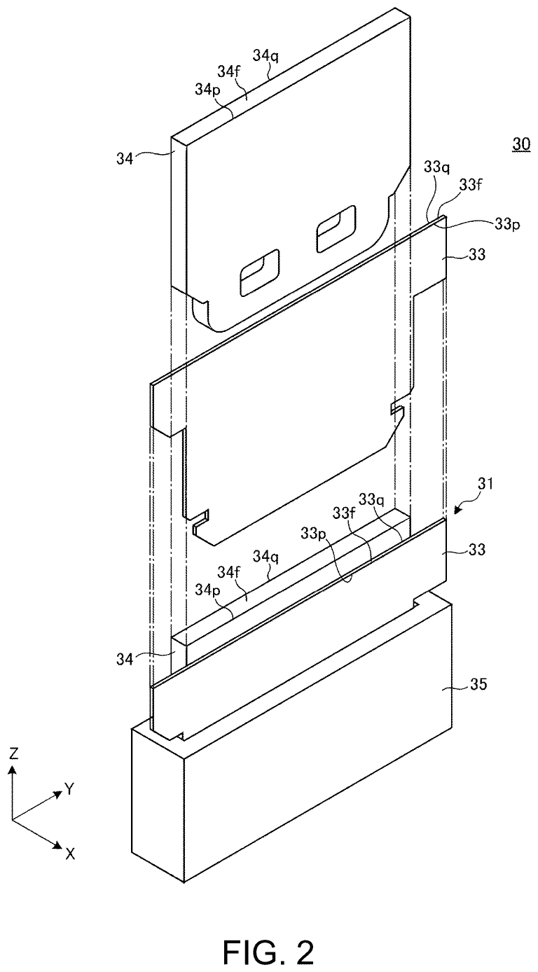

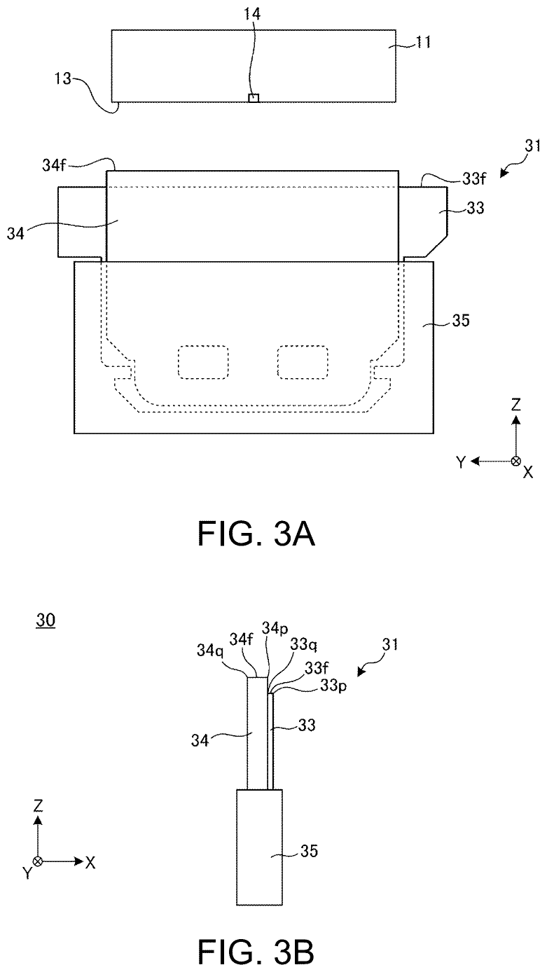

FIGS. 2 and 3 are views illustrating an example of the wiping portion 31 of the wiper unit 30. FIG. 2 is a perspective view, FIG. 3(A) is a view of the wiper unit 30 as viewed from the X direction, and FIG. 3(B) is a view of the wiper unit as viewed from the Y direction. FIG. 2 also illustrates an exploded perspective view of the first wiping member 33 and the second wiping member 34. As illustrated in FIGS. 2 and 3, the wiping portion 31 includes a first wiping member 33 and a second wiping member 34, which are two wiping members having different hardnesses, and a holding portion 35 that holds these two wiping members.

The hardness of the second wiping member 34 is lower than that of the first wiping member 33. In other words, the first wiping member 33 has a higher hardness than the second wiping member 34. Here, the hardness can be, for example, resistance to deformation against a force in the wiping direction. The first wiping member 33 is formed to have a Young's modulus in the range of 400 MPa to 800 MPa, for example. The second wiping member 34 is formed to have a Young's modulus in the range of 0.5 MPa to 100 MPa, for example. In the present embodiment, the first wiping member 33 is formed using, for example, a plastic material such as polypropylene. The second wiping member 34 is formed using, for example, a rubber material such as ethylene propylene rubber.

The first wiping member 33 and the second wiping member 34 are arranged side by side in the wiping direction. The first wiping member 33 is disposed on the +X side in the wiping direction. The second wiping member 34 is disposed on the −X side in the wiping direction.

The first wiping member 33 has a thickness (dimension in the wiping direction) of, for example, about 0.35 mm. The first wiping member 33 has a planar upper surface 33f. The first wiping member 33 has corners 33p and 33q on both sides of the upper surface 33f in the wiping direction. By having the corners 33p and 33q, when the wiping portion 31 moves in the wiping direction, the first wiping member 33 can perform wiping in a state where an edge is applied against the nozzle surface 13. The first wiping member 33 may be formed such that the height in the Z direction is higher at the corner 33q than at the corner 33p. In this case, the upper surface 33f is inclined upward from the corner 33p to the corner 33q.

The second wiping member 34 has a thickness of, for example, about 2 mm. The second wiping member 34 has a planar upper surface 34f. The second wiping member 34 has corners 34p and 34q on both sides of the upper surface 34f in the wiping direction. By having the corners 34p and 34q, when the wiping portion 31 moves in the wiping direction, the second wiping member 34 can perform wiping in a state where an edge is applied against the nozzle surface 13. The second wiping member 34 may be formed such that the height in the Z direction is higher at the corner 34q than at the corner 34p. In this case, the upper surface 34f is inclined upward from the corner 34p to the corner 34q.

The dimension of the first wiping member 33 in the Y direction is similar to the dimension of the ejecting head 11 in the Y direction or larger than the dimension of the ejecting head 11 in the Y direction. The dimension of the second wiping member 34 in the Y direction is similar to the dimension of the nozzle surface 13 of the ejecting head 11 in the Y direction or larger than the dimension of the nozzle surface 13 of the ejecting head 11 in the Y direction. Therefore, the entire region in the Y direction of the nozzle surface 13 of the ejecting head 11 can be wiped by the first wiping member 33 and the second wiping member 34.

The second wiping member 34 protrudes from the holding portion 35 toward the nozzle surface 13 with respect to the first wiping member 33. Therefore, when the wiping portion 31 is raised toward the nozzle surface 13, the second wiping member 34 first comes into contact with the nozzle surface 13. When the wiping portion 31 is raised until the first wiping member 33 comes into contact with the nozzle surface 13, the second wiping member 34 is elastically deformed in a vertical direction.

The holding portion 35 integrally holds the first wiping member 33 and the second wiping member 34. The holding portion 35 detachably holds the first wiping member 33 and the second wiping member 34.

The second drive mechanism 32 reciprocates the wiping portion 31 in the X direction (sub-scanning direction). The X direction (sub-scanning direction), which is the moving direction of the wiping portion 31, is the wiping direction of the wiping portion 31 according to the present embodiment. The wiping direction may be a reciprocating direction in the X direction or a one-way direction.

The second drive mechanism 32 reciprocates the wiping portion 31 in the Z direction (raising and lowering direction, vertical direction). When the second drive mechanism 32 moves the wiping portion 31 in the Z direction, the first wiping member 33 and the second wiping member 34 can be brought into contact with the nozzle surface 13 or can be released from contact. The wiping of the nozzle surface 13 by the wiping portion 31 can be performed by moving the wiping portion 31 in the X direction in a state where the second drive mechanism 32 brings the first wiping member 33 and the second wiping member 34 into contact with the nozzle surface 13.

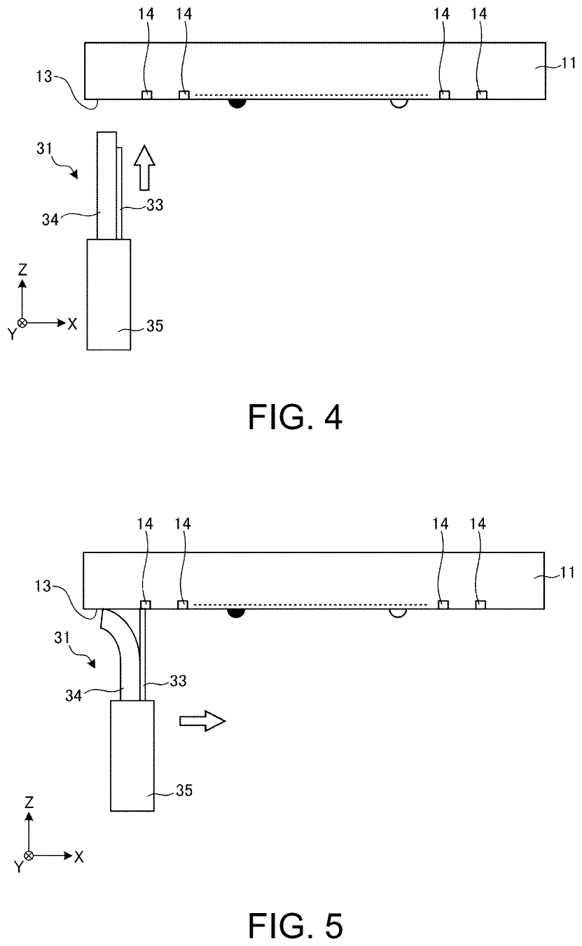

Next, the wiping operation of the printing apparatus 100 configured as described above will be described. FIGS. 4 to 12 are views illustrating an example of the wiping operation by the wiper unit 30. When performing the wiping operation, the ejecting head 11 is moved above the wiper unit 30. From this state, as illustrated in FIG. 4, the second drive mechanism 32 raises the wiping portion 31 toward the nozzle surface 13 of the ejecting head 11. As the wiping portion 31 rises, the second wiping member 34 first comes into contact with the nozzle surface 13. By further raising the wiping portion 31, the first wiping member 33 comes into contact with the nozzle surface 13, and the second wiping member 34 is elastically deformed.

As illustrated in FIG. 5, the second drive mechanism 32 moves the wiping portion 31 in the wiping direction from the state in which the first wiping member 33 and the second wiping member 34 are in contact with the nozzle surface 13. The wiping portion 31 wipes the nozzle surface 13 in a state where the first wiping member 33 is located on the front side in the wiping direction and the second wiping member 34 is located on the rear side in the wiping direction. As the wiping portion 31 moves in the wiping direction, the corners 33p and 34p of the first wiping member 33 and the second wiping member 34 come into contact with the nozzle surface 13 in a state where the upper end sides thereof are bent backward. Therefore, the first wiping member 33 and the second wiping member 34 can perform wiping in a state where an edge is applied against the nozzle surface 13. Since the hardness of the second wiping member 34 is lower than that of the first wiping member 33, the backward deflection becomes large.

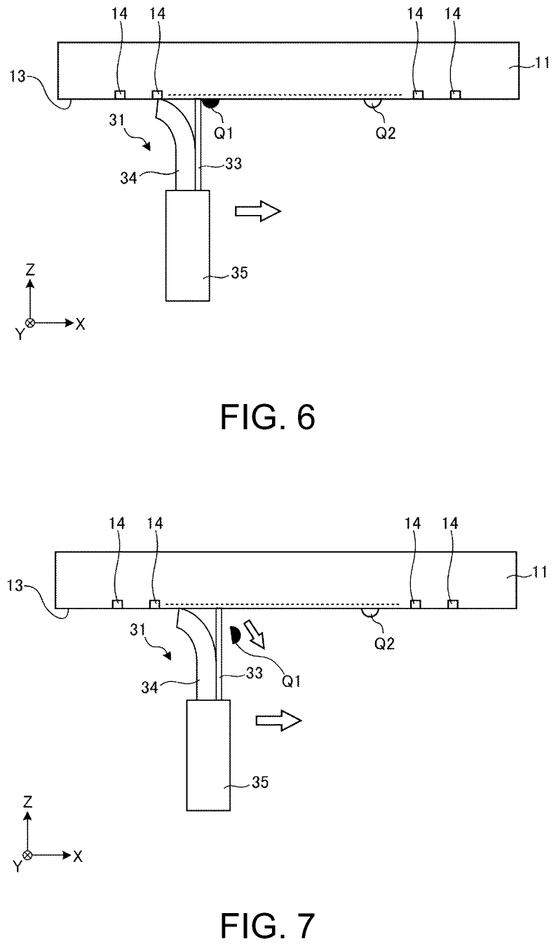

As illustrated in FIGS. 6 and 7, due to the movement of the wiping portion 31, the first wiping member 33 formed using the plastic material can scrape off the dried or solidified ink Q1 adhering to the nozzle surface 13.

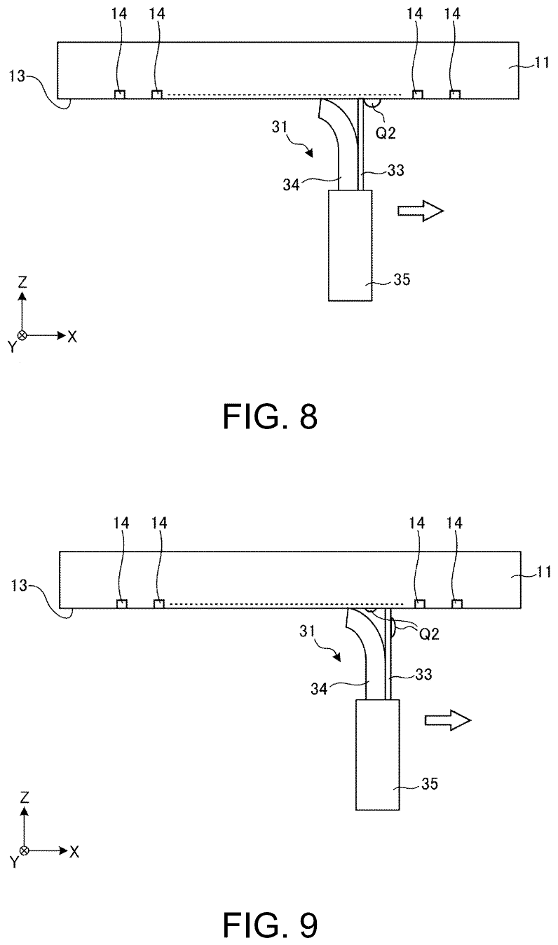

As illustrated in FIGS. 8 to 10, due to the movement of the wiping portion 31, the second wiping member 34 formed using the rubber material can scrape off the ink Q2 in the form of droplets or mist adhered to the nozzle surface 13. Here, as illustrated in FIG. 9, the first wiping member 33 can remove the dried or solidified ink Q1, but may not be able to sufficiently remove the non-dried or non-solidified ink Q2 in the form of droplets or mist. In this case, a part of the ink Q2 remains on the nozzle surface 13.

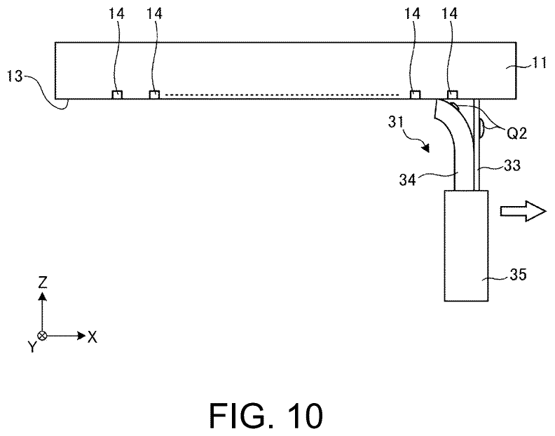

On the other hand, in the present embodiment, since the second wiping member 34 having a hardness lower than that of the first wiping member 33 is provided, the ink Q2 remaining on the nozzle surface 13 can be removed by the second wiping member 34 as illustrated in FIG. 10. Therefore, both the dried or solidified ink Q1 and the ink Q2 in the form of droplets or mist can be appropriately removed by one movement of the wiping portion 31 in the wiping direction.

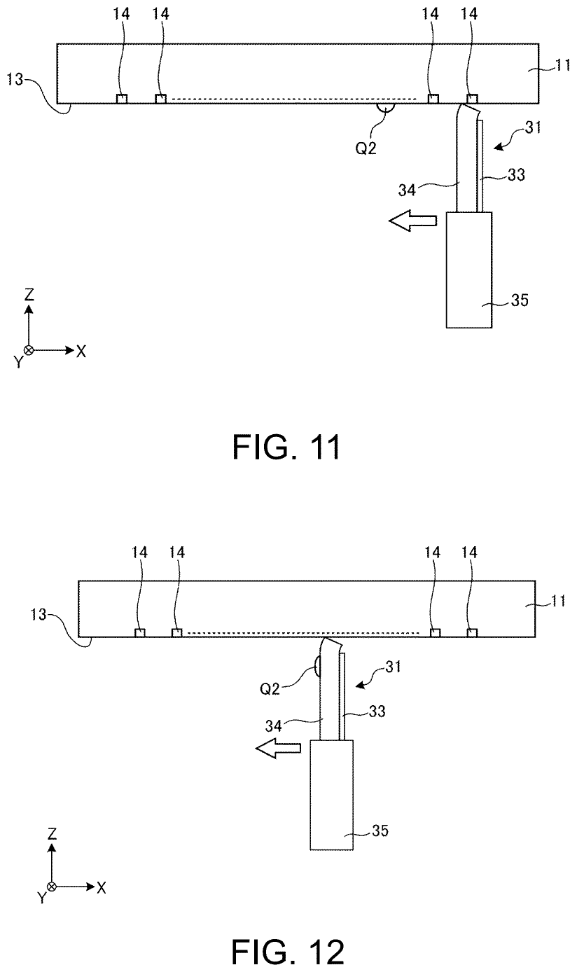

When the ink adhered to the nozzle surface 13 is the ink Q2 in the form of droplets or mist, as illustrated in FIGS. 11 and 12, the wiping portion 31 may be moved so that the second wiping member 34 is in front in the wiping direction. In this case, the ink Q2 can be appropriately removed by the second wiping member 34.

As described above, the printing apparatus 100 according to the present embodiment includes the ejecting head 11 having the nozzle surface 13 in which the plurality of nozzles 14 that eject the ink are formed in a row at predetermined intervals, the wiping portion 31 that wipes the nozzle surface 13, and the driving unit 40 that relatively moves the nozzle surface 13 and the wiping portion 31, in which the ejecting head 11 ejects the ink to the medium M mounted in the printing area while moving in the main scanning direction set in advance, and the wiping portion 31 includes the first wiping member 33 and the second wiping member 34 having different hardnesses arranged side by side in the direction in which the nozzle surface 13 and the wiping portion 31 relatively move at the time of wiping the nozzle surface 13, and the holding portion 35 that integrally holds the first wiping member 33 and the second wiping member 34.

According to this configuration, since the first wiping member 33 and the second wiping member 34 having different hardnesses are integrally held in the wiping portion 31, when the first wiping member 33 and the second wiping member 34 are brought into contact with the nozzle surface 13 and the wiping portion 31 is moved in the wiping direction, both the dried or solidified ink and the ink in the form of mist or droplets can be appropriately removed by one movement.

In the printing apparatus 100 according to the present embodiment, the driving unit 40 includes the first drive mechanism 22 that moves the ejecting head 11 in the main scanning direction set in advance, and the second drive mechanism 32 that moves the wiping portion 31 relative to the nozzle surface 13. According to this configuration, since the driving unit 40 includes the first drive mechanism 22 and the second drive mechanism 32, the ejecting head 11 and the wiping portion 31 can be separately moved.

In the printing apparatus 100 according to the present embodiment, the first wiping member 33 is arranged on one side by the driving unit 40 in the direction in which the nozzle surface 13 and the wiping portion 31 move relative to each other at the time of wiping the nozzle surface 13. The second wiping member 34 is disposed on the other side in the same direction, and has a hardness lower than that of the first wiping member 33. According to this configuration, the ink adhered to the nozzle surface 13 in a dried or solidified state can be appropriately removed by the first wiping member 33 on the front side in the wiping direction. Further, the ink in the form of mist or droplets adhered to the nozzle surface 13 can be appropriately removed by the second wiping member 34 on the rear side in the wiping direction. In this case, the second wiping member 34 can appropriately remove the ink in the form of mist or droplets that cannot be removed in the first wiping member 33.

In the printing apparatus 100 according to the present embodiment, the second wiping member 34 protrudes from the holding portion toward the nozzle surface 13 with respect to the first wiping member 33. According to this configuration, the second wiping member 34 can be elastically deformed in a state where the first wiping member 33 is in contact with the nozzle surface 13.

In the printing apparatus 100 according to the present embodiment, the second drive mechanism 32 can move the wiping portion 31 in the vertical direction orthogonal to the nozzle surface 13. According to this configuration, the first wiping member 33 and the second wiping member 34 can be appropriately brought into contact with the nozzle surface 13 by the drive of the second drive mechanism 32.

In the printing apparatus 100 according to the present embodiment, the second drive mechanism 32 can move the wiping portion 31 in the vertical direction to arrange the first wiping member 33 and the second wiping member 34 at positions in contact with the nozzle surface 13 in a state where the second wiping member 34 is elastically deformed. According to this configuration, the nozzle surface 13 can be wiped in a state where the first wiping member 33 and the second wiping member 34 are appropriately brought into contact with the nozzle surface 13 by the drive of the second drive mechanism 32.

In the printing apparatus 100 according to the present embodiment, the wiping portion 31 is arranged such that the nozzle surface 13 of the ejecting head 11 faces at a predetermined position at least one point on the extension line in the main scanning direction. According to this configuration, the nozzle surface 13 can face the wiping portion 31 by moving the ejecting head 11 in the extension direction in the main scanning direction.

In the printing apparatus 100 according to the present embodiment, assuming that the longest time required for the ejecting head 11 to reach the position facing the wiping portion 31 after ejecting the ink for the last time in the main scanning direction (Y direction) is the longest non-ejection time, for example, ink in which the droplets of the ink adhered to the nozzle surface 13 solidify at least during the longest non-ejection time can be used as the ink. As a result, when the ink solidifies during the movement in the main scanning direction after the ejecting head 11 ejects the ink, the ink can be appropriately wiped by the wiping portion 31.

In the printing apparatus 100 according to the present embodiment, the first wiping member 33 is formed using a non-water-absorbent material, and the second wiping member 34 is formed using a water-absorbent elastic material. According to this configuration, each of the first wiping member 33 and the second wiping member 34 can be formed to have a hardness capable of appropriately removing ink. For example, the solid material, that is, solidified ink can be wiped out by the first wiping member 33, and the ink in the liquid state can be wiped out by the second wiping member 34.

The printing apparatus 100 according to the present embodiment includes the ejecting head 11 having the nozzle surface 13 on which the nozzles 14 for ejecting ink are formed, and the wiper unit for wiping the nozzle surface 13 of the ejecting head 11, and the wiper unit 30 is used as the wiper unit. By including the wiper unit 30 capable of appropriately removing both the dried or solidified ink and the ink in the form of mist or droplets by one movement, the nozzle surface 13 can be suppressed from being wiped more than necessary by the wiping member having a high hardness, and deterioration of the water-repellent treatment of the nozzle surface 13 can be suppressed. As a result, the life of the ejecting head 11 can be prolonged.

The ink used in the printing apparatus 100 according to the present embodiment is an ultraviolet-curable ink. In the ejecting head 11 that ejects the ultraviolet-curable ink, the ink in a dried or cured state and the ink in the form of mist or droplets are likely to be mixed on the nozzle surface 13. According to the present embodiment, both the dried or solidified ink and the ink in the form of mist or droplets can be appropriately removed by one movement of the wiping portion 31.

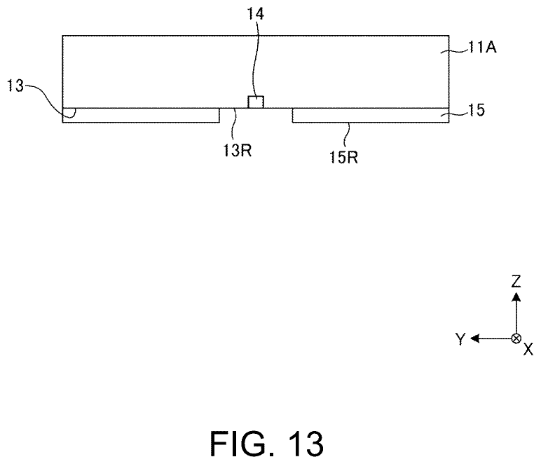

The technical scope of the present invention is not limited to the above embodiment, and can be appropriately changed without departing from the gist of the present invention. FIG. 13 is a view illustrating another example of the ejecting head. As illustrated in FIG. 13, an ejecting head 11A has a configuration in which a nozzle plate 15 is arranged on the nozzle surface 13. The nozzle plate 15 is formed so as to surround a nozzle region 13R of the nozzle surface 13 where the plurality of nozzles 14 are formed. Therefore, on the nozzle surface 13, a step is formed between the nozzle region 13R and a surface 15R of the nozzle plate 15. The step is formed by the thickness of the nozzle plate 15, for example.

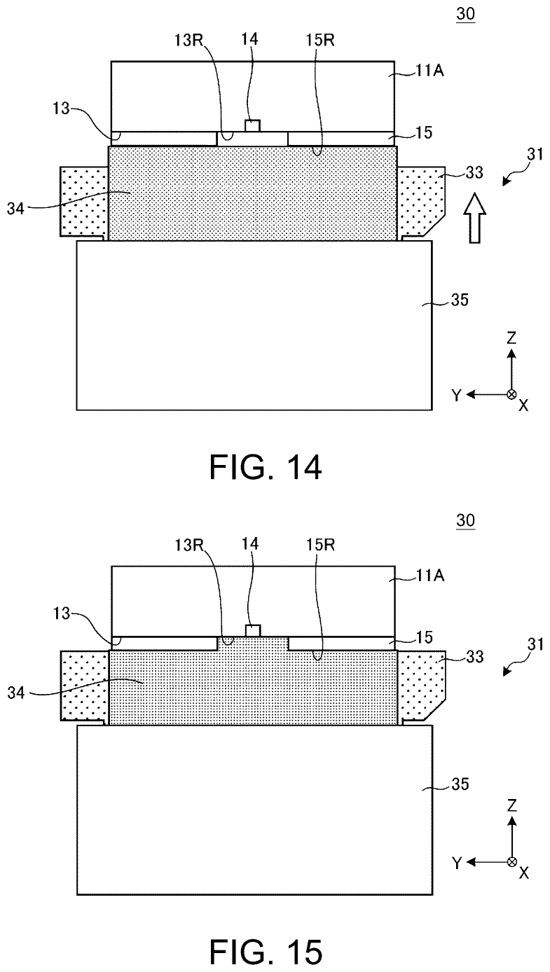

FIGS. 14 to 16 are views illustrating an example of a case where wiping is performed by the wiper unit 30 on the ejecting head 11A illustrated in FIG. 13. As illustrated in FIG. 14, also in a case where a step is formed on the nozzle surface 13, the second drive mechanism 32 similarly raises the wiping portion 31. As the wiping portion 31 rises, the second wiping member 34 first comes into contact with the surface 15R of the nozzle plate 15 as illustrated in FIG. 14.

When the second drive mechanism 32 further raises the wiping portion 31 from this state, the first wiping member 33 comes into contact with the surface 15R of the nozzle plate 15 as illustrated in FIG. 15. Further, a part of the second wiping member 34 is elastically deformed and enters the stepped portion, and comes into contact with the nozzle region 13R of the nozzle surface 13.

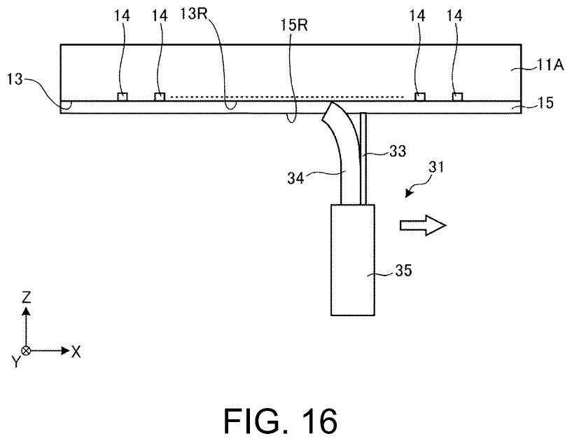

From this state, when the second drive mechanism 32 moves the wiping portion 31 in the wiping direction, the first wiping member 33 wipes the surface 15R of the nozzle plate 15, and a part of the second wiping member 34 entering the stepped portion wipes the nozzle region 13R as illustrated in FIG. 16. As a result, the ink adhered to the nozzle region 13R of the nozzle surface 13 and the surface 15R of the nozzle plate 15 can be appropriately removed with respect to the ejecting head 11A having a step on the nozzle surface 13.

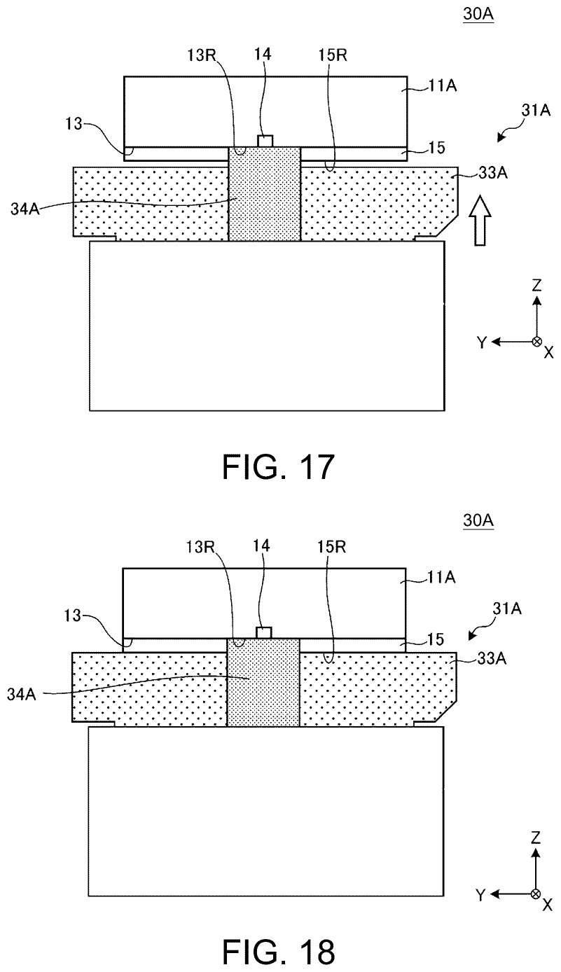

FIGS. 17 and 18 are views illustrating an example of a case where wiping is performed on the ejecting head 11A illustrated in FIG. 13 by a wiper unit 30A according to another configuration. As illustrated in FIGS. 17 and 18, the wiper unit of the present example has a configuration in which the dimension in the Y direction (width direction) of a second wiping member 34A provided in a wiping portion 31A substantially matches the dimension in the Y direction of the nozzle region 13R. Note that a first wiping member 33A has the same configuration as the first wiping member 33 of the wiping portion 31 described above.

When wiping is performed by such a wiper unit 30A, the second drive mechanism 32 raises the wiping portion 31A. As the wiping portion 31A rises, as illustrated in FIG. 17, first, the second wiping member 34A enters the stepped portion of the nozzle surface 13 and comes into contact with the nozzle region 13R of the nozzle surface 13. When the second drive mechanism 32 further raises the wiping portion 31 from this state, the first wiping member 33 comes into contact with the surface 15R of the nozzle plate 15 as illustrated in FIG. 18. Note that the second wiping member 34 elastically deforms in a state of entering the stepped portion and being in contact with the nozzle region 13R.

From this state, when the second drive mechanism 32 moves the wiping portion 31A in the wiping direction, the first wiping member 33A wipes the surface 15R of the nozzle plate 15, and the second wiping member 34A entering the stepped portion wipes the nozzle region 13R. As a result, the ink adhered to the nozzle region 13R of the nozzle surface 13 and the surface 15R of the nozzle plate 15 can be appropriately removed with respect to the ejecting head 11A having a step on the nozzle surface 13.

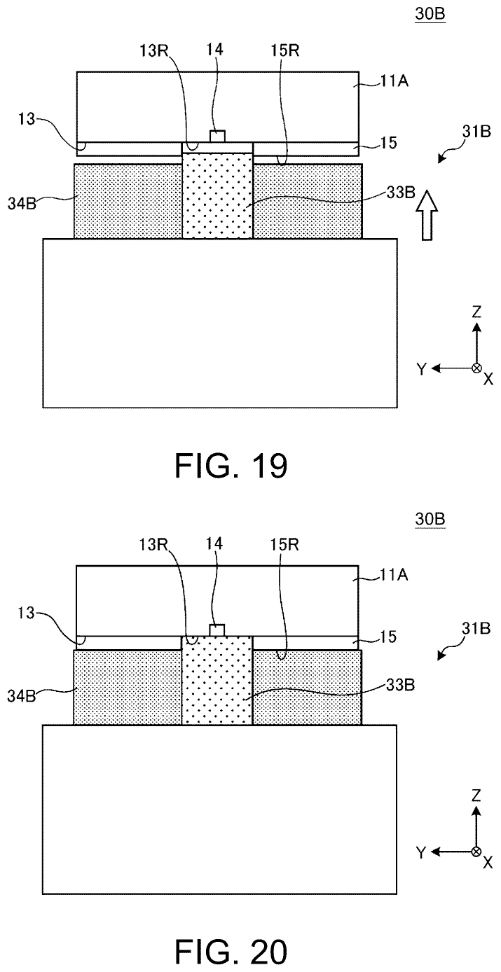

FIGS. 19 to 21 are views illustrating an example of a case where wiping is performed on the ejecting head 11A illustrated in FIG. 13 by a wiper unit 30B according to another configuration. As illustrated in FIGS. 19 and 20, the wiper unit of the present example has a configuration in which the dimension in the Y direction (width direction) of a first wiping member 33B provided in a wiping portion 31B substantially matches the dimension in the Y direction of the nozzle region 13R. The second wiping member 34B has the same configuration as the second wiping member 34 of the wiping portion 31 described above.

When wiping is performed with such a wiper unit, the second drive mechanism 32 raises the wiping portion 31B. As the wiping portion 31B rises, the first wiping member 33B enters the stepped portion of the nozzle surface 13 as illustrated in FIG. 20. When the second drive mechanism further raises the wiping portion 31B from this state, the second wiping member 34B comes into contact with the surface 15R of the nozzle plate 15. Further, by further raising the wiping portion 31B, the first wiping member 33B comes into contact with the nozzle region 13R of the nozzle surface 13 as illustrated in FIG. 20. The second wiping member 34B elastically deforms while being in contact with the surface 15R of the nozzle plate 15.

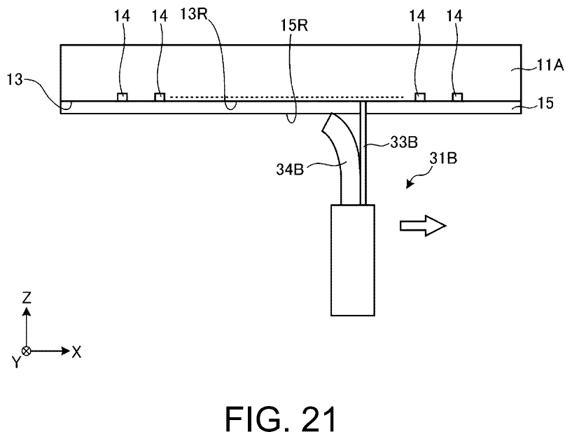

From this state, when the second drive mechanism moves the wiping portion 31B in the wiping direction, the first wiping member 33B wipes the nozzle region 13R of the nozzle surface 13 at the stepped portion, and the second wiping member 34B wipes the surface 15R of the nozzle plate 15, as illustrated in FIG. 21. As a result, the ink adhered to the nozzle region 13R of the nozzle surface 13 and the surface 15R of the nozzle plate 15 can be appropriately removed with respect to the ejecting head 11A having the step on the nozzle surface 13.

In the above embodiment, the case where a plastic material is used as the first wiping member and a rubber material is used as the second wiping member has been described as an example, but the present invention is not limited to this configuration. For example, as the second wiping member, a porous material such as sponge may be used instead of the rubber material.

In addition to the configuration of the above embodiment, in order to increase cleaning efficiency of wiping by the wiper unit, a cleaning solution may be appropriately supplied to the first wiping member and the second wiping member.

In the above-described embodiment, the configuration in which the second drive mechanism 32, which is the driving unit 40, is configurated to raise and lower the wiping portion 31 in the vertical direction has been described as an example, but the present invention is not limited to this configuration. For example, the first drive mechanism 22, which is the driving unit 40, may be capable of moving the ejecting head 11 in the vertical direction orthogonal to the nozzle surface 13. In this case, the first drive mechanism 22 may have a configuration in which the nozzle surface 13 can be arranged at a position in contact with the first wiping member 33 and the second wiping member 34 in a state where the second wiping member 34 is elastically deformed by moving the ejecting head 11 in the vertical direction. As a result, the first wiping member 33 and the second wiping member 34 can be appropriately brought into contact with the nozzle surface 13 by the drive of the first drive mechanism 22.

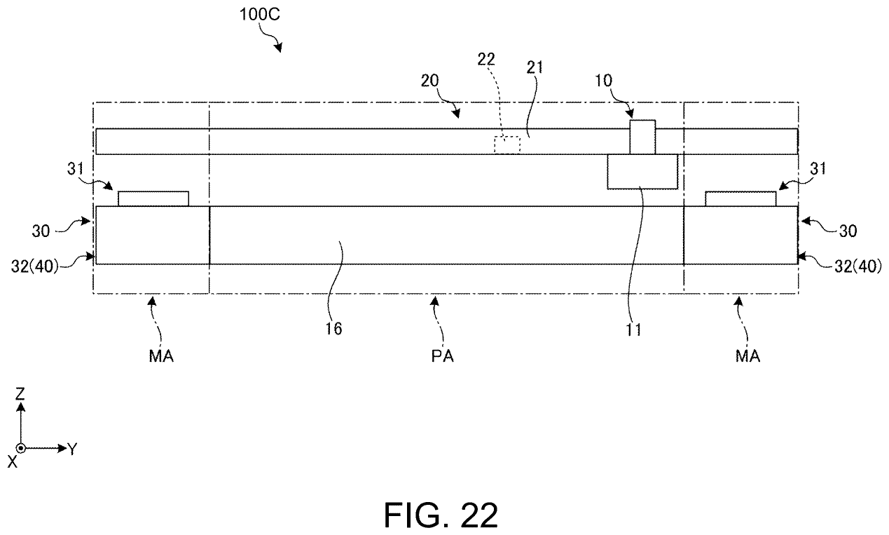

FIG. 22 is a view illustrating an example of a printing apparatus 100C according to another configuration. In the printing apparatus 100C illustrated in FIG. 22, the configuration in which the wiper unit 30 is disposed on the +Y side of the platen 16 has been described as an example, but the present invention is not limited to this configuration. As illustrated in FIG. 22, the wiper unit 30 may be disposed on both the +Y side and the −Y side of the platen 16. In this case, the wiping portion 31 is arranged such that the nozzle surface 13 of the ejecting head 11 faces on the extension line in the Y direction which is the main scanning direction, that is, at two predetermined positions on the +Y side and the −Y side of the platen 16.

### REFERENCE SIGNS LIST

M Medium
Q1, Q2 Ink
2 Recording medium
10 Carriage
11, 11A Ejecting head
12 Light irradiation device
13 Nozzle surface
13R Nozzle region
14 Nozzle
15 Nozzle plate
15R Surface
16 Platen
20 Guide mechanism
21 Guide rail
22 First drive mechanism
30 Wiper unit
31, 31A, 31B Wiping portion
32 Second drive mechanism
33, 33A, 33B First wiping member
33f, 34f Upper surface
33p, 33q, 34p, 34q Corner
34, 34A, 34B Second wiping member
35 Holding portion
40 Driving unit
100 Printing apparatus

1. A printing apparatus comprising:
an ejecting head having a nozzle surface in which a plurality of nozzles for ejecting ink are formed in a row at predetermined intervals;
a wiping portion that wipes the nozzle surface; and
a driving unit that relatively moves the nozzle surface and the wiping portion,
wherein the ejecting head ejects the ink to a printing medium mounted in a printing area while moving in a main scanning direction set in advance, and
the wiping portion includes two wiping members having different hardnesses arranged side by side in a direction in which the nozzle surface and the wiping portion relatively move at the time of wiping the nozzle surface, and a holding portion that integrally holds the two wiping members.

2. The printing apparatus as set forth in claim 1, wherein
the driving unit includes:
a first drive mechanism that moves the ejecting head in the main scanning direction set in advance; and
a second drive mechanism that moves the wiping portion relative to the nozzle surface.

3. The printing apparatus as set forth in claim 1, wherein
the two wiping members include a first wiping member arranged on one side by the driving unit in a direction in which the nozzle surface and the wiping portion move relative to each other at the time of wiping the nozzle surface, and a second wiping member arranged on the other side in the same direction and having a hardness lower than that of the first wiping member.

4. The printing apparatus as set forth in claim 3, wherein
the second wiping member protrudes from the holding portion to the nozzle surface side with respect to the first wiping member.

5. The printing apparatus as set forth in claim 3, wherein
the driving unit is configured to be capable of moving the wiping portion in a vertical direction orthogonal to the nozzle surface.

6. The printing apparatus as set forth in claim 3, wherein
the driving unit is configured to be capable of moving the ejecting head in a vertical direction orthogonal to the nozzle surface, and arranging the nozzle surface at a position in contact with the first wiping member and the second wiping member in a state where the second wiping member is elastically deformed by moving the ejecting head in the vertical direction.

7. The printing apparatus as set forth in claim 5, wherein
the driving unit is configured to be capable of moving the wiping portion in the vertical direction to arrange the first wiping member and the second wiping member at positions in contact with the nozzle surface in a state where the second wiping member is elastically deformed.

8. The printing apparatus as set forth in claim 1, wherein
the wiping portion is disposed to face the nozzle surface of the ejecting head at at least one predetermined position on a line extending in the main scanning direction.

9. The printing apparatus as set forth in claim 1, wherein
a longest time required for the ejecting head to reach a position facing the wiping portion after ejecting the ink for the last time in the main scanning direction is defined as a longest non-ejection time, and
the ink is ink in which droplets of the ink adhered to the nozzle surface solidify at least during the longest non-ejection time.

10. The printing apparatus as set forth in claim 3, wherein
the first wiping member is formed using plastic or a resinous material having a Young's modulus of 400 MPa to 800 MPa, and
the second wiping member is formed using an elastic material having a Young's modulus of 0.5 MPa to 100 MPa.

11. The printing apparatus as set forth in claim 3, wherein
the first wiping member is formed using a non-water-absorbent material, and
the second wiping member is formed using a water-absorbent elastic material.

12. The printing apparatus as set forth in claim 1, wherein
the ejecting head further includes a nozzle plate arranged so as to surround a nozzle region where the nozzle is formed in the nozzle surface, and
a step corresponding to a thickness of the nozzle plate is formed between the nozzle surface and a lower surface of the nozzle plate when the nozzle surface is directed downward.

13. The printing apparatus as set forth in claim 6, wherein
the driving unit is configured to be capable of moving the wiping portion in the vertical direction to arrange the first wiping member and the second wiping member at positions in contact with the nozzle surface in a state where the second wiping member is elastically deformed.

14. A printing apparatus comprising:
an ejecting head having a nozzle surface in which a plurality of nozzles for ejecting ink are formed in a row at predetermined intervals;
a wiping portion that wipes the nozzle surface; and
a driving unit that relatively moves the nozzle surface and the wiping portion,
wherein the ejecting head ejects the ink to a printing medium mounted in a printing area while moving in a main scanning direction set in advance, and
the wiping portion includes a first wiping member arranged on one side by the driving unit in a direction in which the nozzle surface and the wiping portion move relative to each other at the time of wiping the nozzle surface, and a second wiping member arranged on the other side in the same direction and having a hardness lower than that of the first wiping member.

15. The printing apparatus as set forth in claim 14, wherein
the second wiping member protrudes to the nozzle surface side with respect to the first wiping member.

16. The printing apparatus as set forth in claim 14, wherein
the driving unit is configured to be capable of moving the wiping portion in a vertical direction orthogonal to the nozzle surface.

17. The printing apparatus as set forth in claim 14, wherein
the driving unit is configured to be capable of moving the ejecting head in a vertical direction orthogonal to the nozzle surface, and arranging the nozzle surface at a position in contact with the first wiping member and the second wiping member in a state where the second wiping member is elastically deformed by moving the ejecting head in the vertical direction.

18. The printing apparatus as set forth in claim 16, wherein
the driving unit is configured to be capable of moving the wiping portion in the vertical direction to arrange the first wiping member and the second wiping member at positions in contact with the nozzle surface in a state where the second wiping member is elastically deformed.

19. The printing apparatus as set forth in claim 17, wherein
the driving unit is configured to be capable of moving the wiping portion in the vertical direction to arrange the first wiping member and the second wiping member at positions in contact with the nozzle surface in a state where the second wiping member is elastically deformed.

20. A wiping portion adapted to wipe a nozzle surface of an ejecting head of a printing apparatus, comprising:
two wiping members having different hardnesses arranged side by side in a direction in which the nozzle surface and the wiping portion relatively move at the time of wiping the nozzle surface; and
a holding portion that integrally holds the two wiping members.
